(19) United States
(12) Patent Application Publication
(10) Pub. No.: US 2012/0259930 A1
(43) Pub. Date: Oct. 11, 2012

(54) COMPUTER SERVER AND METHOD FOR SHARING DATA IN GROUPS

(75) Inventor: YU-CHI WU, Tu-Cheng (TW)

(73) Assignee: CHI MEI COMMUNICATION SYSTEMS, INC., Tu-Cheng (TW)

(21) Appl. No.: 13/429,458

(22) Filed: Mar. 26, 2012

(30) Foreign Application Priority Data
Apr. 11, 2011 (TW) 100112469

(51) Int. Cl. G06F 15/16; G06F 17/30

(52) U.S. Cl. 709/206; 707/769

(57) ABSTRACT

A method for sharing data in a group using a computer server establishes sharing groups to share data queried by a communication device. A query is sent to the computer server using a Subscriber Identity Module Application Toolkit (STK) application in the communication device. The method receives a query from the communication device, acquires a query result, and transmits the query result to the communication device and group members in one or more selected sharing groups in response to receiving a group selection command from the communication device.

### BACKGROUND

1. Technical Field

Embodiments of the present disclosure relate to data sharing technology, and particularly to a computer server and method for sharing data in groups.

2. Description of Related Art

Subscriber Identity Module Application Toolkit (STK) is a standard of the Global System for Mobile communication (GSM) system which enables the Subscriber Identity Module (SIM) to initiate actions for various value-added services. For example, a user may query relevant data (e.g., stock data) using the STK application built-in a communication device. Although the user may use the STK application to acquire various information, it is not conveniently for the user to share the acquired information with friends. For example, the user has to create a new message, input the acquired information in the new message, and input corresponding phone numbers to send to other people. This is inconvenient and time consuming.

### BRIEF DESCRIPTION OF THE DRAWINGS

FIG. 1 is a schematic diagram of one embodiment of a computer server in communication with a plurality of communication devices.

FIG. 2 is a block diagram of one embodiment of a sharing system in the computer server of FIG. 1.

FIG. 3 is a flowchart of one embodiment of a method for sharing data in a group using the sharing system of FIG. 2.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

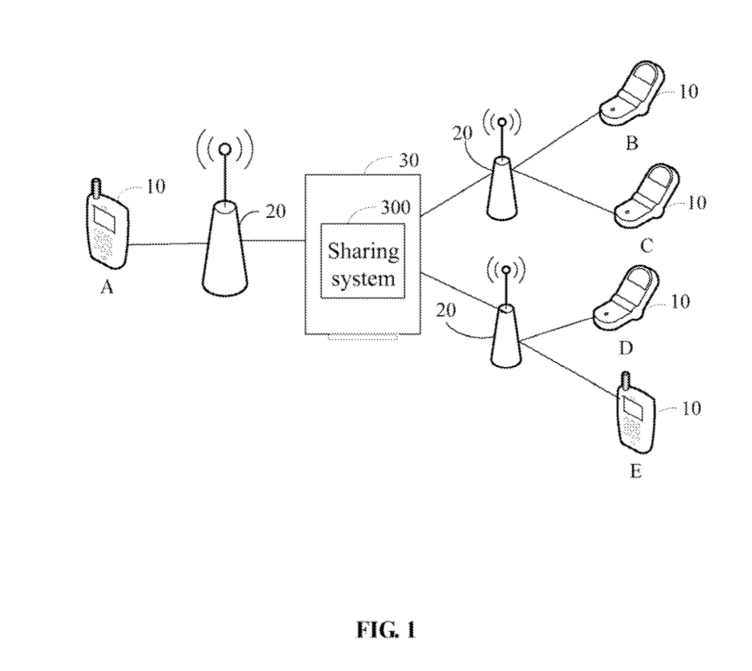

FIG. 1 is a schematic diagram of one embodiment of a computer server 30 in communication with a plurality of communication devices 10. The computer server 30 is connected to the communication devices 10 through wireless base stations (not shown in FIG. 1). In some embodiments, the computer server 30 may be a host computer or any other computing device that is provided by a service provider. The communication devices 10 may be mobile phones, personal digital assistants (PDAs), tablet computers, or personal computers.

The computer server 30 includes a sharing system 300. In some embodiments, the sharing system 300 may be used to establish one or more sharing groups in the computer server 30 according to user requirements from the communication devices 10, and share specific data with group members in selected sharing groups. A detailed description of the sharing system 300 will be given in the following paragraphs.

The computer server 30 further includes a storage device 34 providing one or more memory functions, and at least one processor 32. In one embodiment, the sharing system 300 may include computerized instructions in the form of one or more programs that are executed by the at least one processor 32 and stored in the storage device 34.

The storage device 34 stores one or more programs, such as programs of the operating system, other applications of the electronic device 1, and various kinds of data, such as images and videos. In some embodiments, the storage device 34 may include a memory of the computer server 30 and/or an external storage card, such as a memory stick, a smart media card, a compact flash card, or any other type of memory card. FIG. 1 illustrates only one example of the computer server 30 that may include more or fewer components than as illustrated, or have a different configuration of the various components.

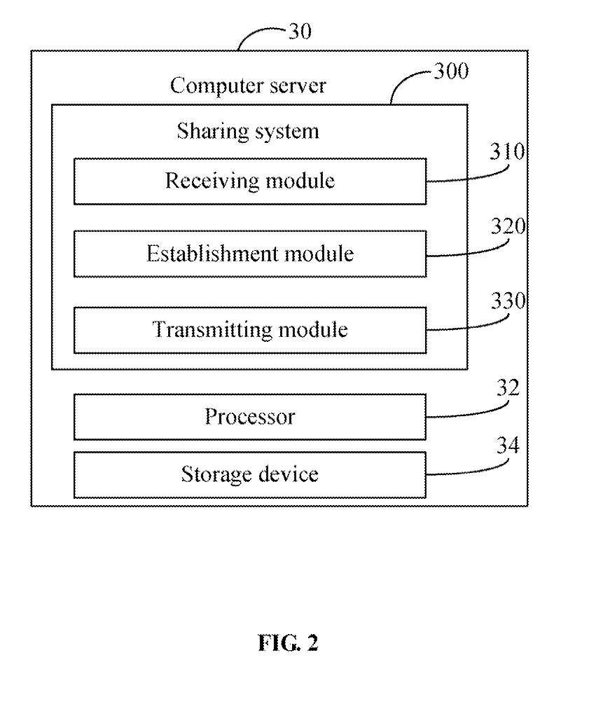

FIG. 2 is a block diagram of one embodiment of the sharing system 300 in the computer server 30 of FIG. 1. In one embodiment, the sharing system 300 may include one or more modules, for example, a receiving module 310, an establishment module 320, and a transmitting module 330. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

For simplification, one communication device 10 (e.g., a communication device “A” as shown in FIG. 1) is illustrated as follows. In some embodiments, the communication device 10 include a Subscriber Identity Module Application Toolkit (STK) application. The STK application may be used in the Global System for Mobile communication (GSM) system which enables the Subscriber Identity Module (SIM) to initiate actions for various value-added services. For example, a user of the communication device 10 may query relevant data (e.g., stock data) using the STK application.

Before sharing data, one or more sharing groups need to be established. In some embodiments, the user may send one or more group establishment commands from the communication device 10 to the computer server 30. Each of the group establishment commands may include, but is not limited to, a phone number list that records phone numbers of group members. For example, the user of the communication device “A” sends a group establishment command including phones numbers of the communication devices “B” and “C”, and sends a group establishment command including phones numbers of the communication devices “D” and “E”. That is, two sharing groups are needed to be established in the computer server 30.

The receiving module 310 receives the group establishment commands from the communication device 10. The establishment module 320 establishes one or more sharing groups according to the group establishment commands. In some embodiments, the sharing groups are established for sharing data queried by a specific communication device (e.g., the communication device 10) using the STK application. Each of the sharing groups provides the phone number list of the phone numbers of the group members. In some embodiments, the communication device 10 also comprises the one or more sharing groups established in the computer server 30. The sharing groups established in the communication device 10 may be the same as the sharing groups in the computer server 30.

In other embodiments, the establishment module 320 may distinguish the sharing groups from other user-defined groups (e.g., contact groups) by regarding the sharing groups as STK groups, as the sharing groups are used to share data queried by the communication device 10 through the STK application.

After the sharing groups are established, the user may query relevant data using the STK application of the communication device 10. For example, a stock data search program is run bases on the STK application, and the user may input stock symbol in the stock data search program to query stock information in the computer server 30. The communication device 10 sends the query to the computer server 30.

The receiving module 310 receives the query from the communication device 10. The transmitting module 330 queries data according to the query, and acquires a query result. In a first embodiment, before transmitting the query result, the transmitting module 330 transmits a prompt message to the communication device 10 to determine if one or more sharing groups are needed to be selected to share the query result. The user may select one or more sharing groups to share the query result, or not share any data with the sharing groups.

If one or more sharing groups are selected, a group selection command is sent from the communication device 10 to the computer server 30. The transmitting module 330 transmits the query result to the communication device 10 and group members in the one or more selected sharing groups in response to receiving the group selection command from the communication device 10.

If no sharing group is selected, a confirmation is sent from the communication device 10 to the computer server 30, the confirmation represents that no sharing group is selected. The transmitting module 330 transmits the query result to the communication device 10 in response to receiving the confirmation.

In a second embodiment, before transmitting the query result, the receiving module 310 recognizes the query sent from the STK application of the communication device 10 first, then the transmitting module 330 transmits the prompt message to the communication device 10. That is, in the first embodiment, the transmitting module 330 transmits the prompt message directly, regardless whether the query is sent from the STK application. In the second embodiment, the transmitting module 330 transmits the prompt message under the condition that the query is sent from the STK application.

The computer server 30 and the communication device 10 transmit corresponding data (e.g., the group establishment commands, the prompt message, the group selection command, the confirmation, and the query results) between each other using short message service (SMS) messages, multimedia messaging service (MMS) messages, or E-mails.

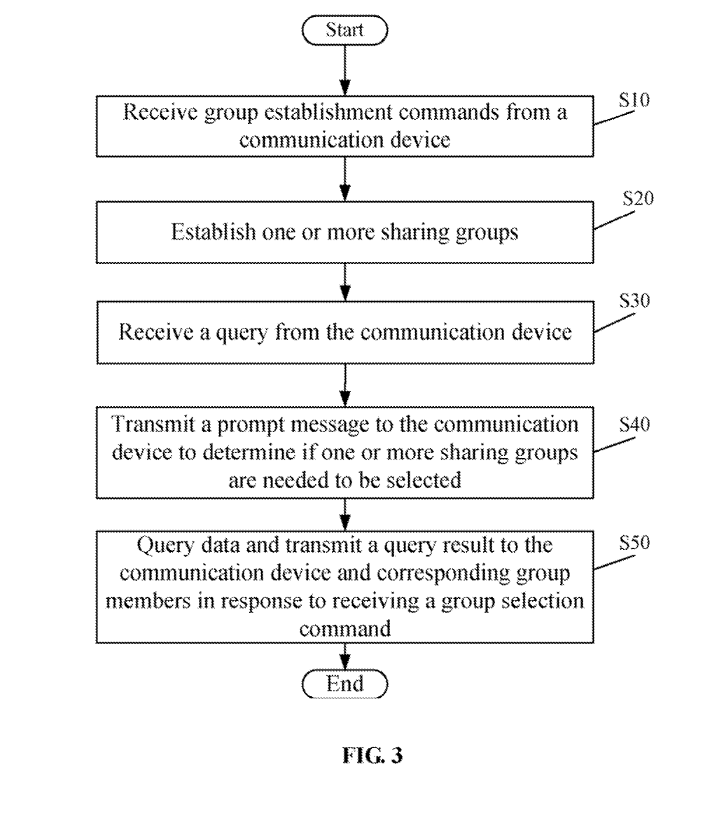

FIG. 3 is a flowchart of one embodiment of a method for sharing data in a group using the sharing system 300 of FIG. 2. Depending on the embodiment, additional blocks may be added, others removed, and the ordering of the blocks may be changed.

In block S10, the receiving module 310 receives group establishment commands from the communication device 10.

In block S20, the establishment module 320 establishes one or more sharing groups according to the group establishment commands As mentioned above, each of the sharing groups provides the phone number list of the phone numbers of the group members.

After the sharing groups are established, the user may query relevant data using the STK application of the communication device 10. The communication device 10 sends the query to the computer server 30.

In block S30, the receiving module 310 receives the query from the communication device 10.

In block S40, the transmitting module 330 transmits a prompt message to the communication device 10 to determine if one or more sharing groups are needed to be selected to share the query result. The user may select one or more sharing groups to share the query result, or not share any data with the sharing groups. If one or more sharing groups are selected, a group selection command is sent from the communication device 10 to the computer server 30. If no sharing group is selected, a confirmation is sent from the communication device 10 to the computer server 30, the confirmation represents that no sharing group is selected.

In block S50, the transmitting module 330 queries data, acquires a query result, and transmits the query result to the communication device 10 and group members in the one or more selected sharing groups in response to receiving the group selection command from the communication device 10, or transmits the query result to the communication device 10 in response to receiving the confirmation.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computer-implemented method for sharing data in a group using a computer server comprising a processor, the computer server in communication with a communication device, the communication device comprising a Subscriber Identity Module Application Toolkit (STK) application, the method comprising execution of the steps comprising:
establishing one or more sharing groups to share data queried by the communication device in response to receiving group establishment commands from the communication device;
receiving a query from the communication device, the communication device transmitting the query to the computer server using the STK application;
querying data according to the query and acquiring a query result; and
transmitting the query result to the communication device and group members in one or more selected sharing groups in response to receiving a group selection command from the communication device.

2. The method according to claim 1, further comprising:
recognizing the query sent from the STK application of the communication device; and
transmitting a prompt message to the communication device to determine if one or more sharing groups are needed to be selected to share the query result.

3. The method according to claim 2, further comprising:
transmitting the query result to the communication device in response to receiving a confirmation that no sharing group is selected.

4. The method according to claim 1, wherein each of the one or more sharing groups provides a phone number list to record phone numbers of the group members in the sharing group.

5. The method according to claim 1, wherein the communication device comprises the one or more sharing groups established in the computer server.

6. The method according to claim 1, wherein the computer server and the communication device transmit data between each other using short message service (SMS) messages or multimedia messaging service (MMS) messages.

7. A computer server, the computer server in communication with a communication device, the communication device comprising a Subscriber Identity Module Application Toolkit (STK) application, the computer server comprising:
a storage device;
at least one processor; and
one or more modules that are stored in the storage device and executed by the at least one processor, the one or more modules comprising:
a receiving module that receives group establishment commands from the communication device;
an establishment module that establishes one or more sharing groups to share data queried by the communication device according to the group establishment commands;
the receiving module that further receives a query from the communication device, the communication device transmitting the query to the computer server using the STK application; and
a transmitting module that queries data according to the query, acquires a query result, and transmits the query result to the communication device and group members in one or more selected sharing groups in response to receiving a group selection command from the communication device.

8. The computer server according to claim 7, wherein the receiving module further recognizes the query sent from the STK application of the communication device, and the transmitting module further transmits a prompt message to the communication device to determine if one or more sharing groups are needed to be selected to share the query result.

9. The computer server according to claim 8, wherein the transmitting module further transmits the query result to the communication device in response that the receiving module receives a confirmation that no sharing group is selected.

10. The computer server according to claim 7, wherein each of the one or more sharing groups provides a phone number list to record phone numbers of the group members in the sharing group.

11. The computer server according to claim 7, wherein the communication device comprises the one or more sharing groups established in the computer server.

12. The computer server according to claim 7, wherein the computer server and the communication device transmit data between each other using short message service (SMS) messages or multimedia messaging service (MMS) messages.

13. A non-transitory storage medium having stored instructions that, when executed by a processor of a computer server, causes the computer server to perform a method for sharing data in a group using the computer server, the computer server in communication with a communication device, the communication device comprising a Subscriber Identity Module Application Toolkit (STK) application, the method comprising:
establishing one or more sharing groups to share data queried by the communication device in response to receiving group establishment commands from the communication device;
receiving a query from the communication device, the communication device transmitting the query to the computer server using the STK application;
querying data according to the query and acquiring a query result; and
transmitting the query result to the communication device and group members in one or more selected sharing groups in response to receiving a group selection command from the communication device.

14. The non-transitory storage medium according to claim 13, wherein the method further comprises:
recognizing the query sent from the STK application of the communication device; and
transmitting a prompt message to the communication device to determine if one or more sharing groups are needed to be selected to share the query result.

15. The non-transitory storage medium according to claim 14, wherein the method further comprises:
transmitting the query result to the communication device in response to receiving a confirmation that no sharing group is selected.

16. The non-transitory storage medium according to claim 13, wherein each of the one or more sharing groups provides a phone number list to record phone numbers of the group members in the sharing group.

17. The non-transitory storage medium according to claim 13, wherein the communication device comprises the one or more sharing groups established in the computer server.

18. The non-transitory storage medium according to claim 13, wherein the computer server and the communication device transmit data between each other using short message service (SMS) messages or multimedia messaging service (MMS) messages.
